(19) United States
(12) Patent Application Publication
(10) Pub. No.: US 2012/0089376 A1
(43) Pub. Date: Apr. 12, 2012

(54) APPARATUS AND METHOD FOR MAPPING AND VISUALIZING TIME-SERIES INFORMATION TO 3D SPATIAL MODEL

(75) Inventors: Hak Cheol KIM, Daejeon (KR); Ki Jung Lee, Gyeonggi-do (KR); Chang Rak Yoon, Daejeon (KR); Kyung Ok Kim, Daejeon (KR); Sung Woong Shin, Daejeon (KR); Jae Chul Kim, Daejeon (KR); Seong Ho Lee, Daejeon (KR); Yoon Seop Chang, Daejeon (KR)

(73) Assignee: Electronics and Telecommunications Research Institute, Daejeon (KR)

(21) Appl. No.: 13/312,330

(22) Filed: Dec. 6, 2011

(30) Foreign Application Priority Data
Oct. 12, 2010 (KR) 10-2010-0126555

(51) Int. Cl. G06F 17/50

(52) U.S. Cl. 703/1

(57) ABSTRACT

The method includes generating a 3D facility model for time-series information mapping using a 3D facility model, receiving input information on a desired time-series information type and a time-series information showing method, retrieving time-series information required to be visualized on the basis of the input information on the time-series information type and the time-series information showing method, mapping the retrieved time-series information to the generated 3D facility model according to the input time-series information showing method, and integratedly visualizing the 3D facility model and the time-series information mapped to the 3D facility model. When the apparatus and method are used, household-specific time-series information is precisely mapped and visualized to the corresponding 3D positions of a 3D spatial model, so that the time-series information in a 3D virtual city model can be integratedly visualized.

### CLAIM FOR PRIORITY

This application claims priority to Korean Patent Application No. 10-2010-0126555 filed on Dec. 10, 2010 in the Korean Intellectual Property Office (KIPO), the entire contents of which are hereby incorporated by reference.

### BACKGROUND

1. Technical Field

Example embodiments of the present invention relate in general to an apparatus and method for mapping and visualizing time-series information to a three-dimensional (3D) spatial model, and more particularly, to an apparatus and method for precisely mapping and visualizing time-series information to a 3D virtual city model including buildings, facilities, and so on.

2. Related Art

Nowadays, time-series data in various forms is obtained in units of buildings or households at predetermined time intervals, but expressed in the form of a simple table, etc. separately from a building model that is a measurement target.

For example, contractor information, measurement time, amounts used, etc. are expressed as electricity usage data in the form of a simple table, or variation over time is expressed in the form of a simple graph, etc. separately from related space information. Thus, it is difficult to know spatial distribution of various types of time-series information obtained from a 3D space.

Lately, some methods of showing information based on a geographical space at the corresponding position on a 3D virtual city model have been suggested.

However, existing technology shows content on a 3D virtual space using location information alone, and thus, when a single building model includes many pieces of time-series information, it is impossible to accurately show the information with the building model. For example, when information is shown on the space of a complex building such as an apartment that is one unit building in which many households reside using location information alone, resident-specific time-series information cannot be accurately shown.

In other words, it is difficult to accurately know 3D spatial distribution of time-series data using existing technology.

Thus, a technique is required to precisely map and show time-series information obtained according to households to the corresponding household positions of a 3D building model of a 3D virtual city model. Since a 3D virtual city model is a huge amount of data, a technique is required to show the 3D virtual city model at the level of detail (LOD) dependent on a zoom level. To this end, an LOD technique is used. Consequently, to integrate and visualize time-series information and a 3D virtual city model, a technique of automatically transforming household-specific time-series information according to an LOD and mapping and showing the transformed time-series information to a 3D virtual city model corresponding to the LOD is required.

### SUMMARY

Accordingly, example embodiments of the present invention are provided to substantially obviate one or more problems due to limitations and disadvantages of the related art.

Example embodiments of the present invention provide an apparatus for mapping and visualizing time-series information to a three dimensional (3D) spatial model, capable of precisely mapping and visualizing household-specific time-series information to the corresponding household geometry positions of a 3D facility model in consideration of a zoom level.

Example embodiments of the present invention also provide a method of mapping and visualizing time-series information to, a 3D spatial model, capable of precisely mapping and visualizing household-specific time-series information to the corresponding household geometry positions of a 3D facility model in consideration of a zoom level.

In some example embodiments, an apparatus for mapping and visualizing time-series information to a 3D spatial model includes: a time-series information provider configured to store household-specific time-series information; a spatial information provider configured to store a 3D facility model; a time-series information mapping 3D facility model generator configured to receive the 3D facility model from the spatial information provider and generate a 3D facility model for time-series information mapping; a user query processor configured to receive a type of desired time-series information and a time-series information showing method input by a user; a time-series information retriever configured to retrieve the desired time-series information input to the user query processor from the time-series information provider; a time-series information 3D facility mapper configured to map the desired time-series information retrieved by the time-series information retriever to the 3D facility model for time-series information mapping generated by the time-series information mapping 3D facility model generator according to the time-series information showing method input to the user query processor; and a time-series information 3D facility mapping integration visualizer configured to integratedly visualize the mapping result of the time-series information 3D facility mapper.

The time-series information provider may store at least one of information on groups constituted of households and time-series information according to the groups constituted of the households in addition to the household-specific time-series information.

The spatial information provider may additionally store two-dimensional (2D) map information and building information including building registration information and building design drawings. Here, the time-series information mapping 3D facility model generator may generate the 3D facility model for time-series information mapping by additionally using the 2D map information and the building information including the building registration information and the building design drawings provided by the spatial information provider.

The time-series information retriever and the time-series information 3D facility mapper may determine a zoom level of the expression information on the basis of the time-series information showing method input through the user query processor according to a current visualization zoom level.

The time-series information 3D facility mapping integration visualizer may clip and visualize the mapping result of the time-series information 3D facility mapper centering on an area included in a current screen.

The spatial information provider may additionally provide 3D terrain information and video information, and the time-series information 3D facility mapping integration visualizer may visualize the mapping result of the time-series information 3D facility mapper using the 3D terrain information and the video information.

In other example embodiments, a method of mapping and visualizing time-series information to a 3D spatial model includes: a time-series information mapping 3D facility model generation step of generating a 3D facility model for time-series information mapping using a 3D facility model; a user request input step of receiving input information on a type of desired time-series information and a time-series information showing method; a time-series information retrieval step of retrieving time-series information required to be visualized on the basis of the input information on the type of time-series information and the time-series information showing method; a time-series information mapping step of mapping the retrieved time-series information to the generated 3D facility model according to the input time-series information showing method; and a time-series information visualization step of integratedly visualizing the 3D facility model and the time-series information mapped to the 3D facility model.

The time-series information may be at least one of household-specific time-series information and time-series information according to groups constituted of households.

The time-series information mapping 3D facility model generation step may include generating the 3D facility model for time-series information mapping using 2D map information and building information including building registration information and building design drawings in addition to the 3D facility model.

The time-series information retrieval step and the time-series information mapping step may include determining the time-series information to be retrieved and a zoom level of the time-series information to be shown on the basis of the time-series information showing method input in the user request input step.

The time-series information visualization step may include clipping and visualizing the mapping result of the time-series information mapping step centering on an area included in a current screen.

The time-series information visualization step may include visualizing the mapping result of the time-series information mapping step using 3D terrain information and video information.

### BRIEF DESCRIPTION OF DRAWINGS

Example embodiments of the present invention will become more apparent by describing in detail example embodiments of the present invention with reference to the accompanying drawings, in which:

FIG. 1 is a block diagram of an apparatus for mapping and visualizing time-series information to a three-dimensional (3D) spatial model according to an example embodiment of the present invention;

FIG. 2 is a flowchart illustrating a method of mapping and visualizing time-series information to a 3D spatial model according to an example embodiment of the present invention;

FIG. 3 is a conceptual diagram of an example in which time-series information is visualized according to building groups using a mapping and visualization method according to an example embodiment of the present invention;

FIG. 4 is a conceptual diagram of an example in which building-unit-specific time-series information is visualized using a mapping and visualization method according to an example embodiment of the present invention;

FIG. 5 is a conceptual diagram of an example in which time-series information according to households in a unit building is visualized using a mapping and visualization method according to an example embodiment of the present invention; and

FIG. 6 is a conceptual diagram of another example in which time-series information according to households in a building is visualized using a mapping and visualization method according to an example embodiment of the present invention.

### DESCRIPTION OF EXAMPLE EMBODIMENTS OF THE PRESENT INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” with another element, it can be directly connected or coupled with the other element or intervening elements may be present. In contrast, when an element is referred to as being “directly connected” or “directly coupled” with another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Hereinafter, example embodiments of the present invention will be described in detail with reference to the appended drawings.

Apparatus for Mapping and Visualizing Time-Series Information to 3D Spatial Model According to Example Embodiment of Present Invention

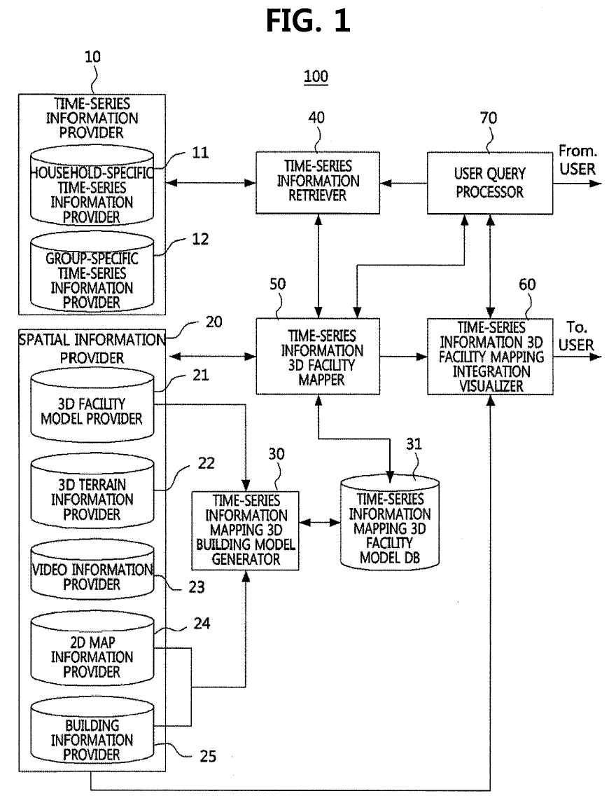

FIG. 1 is a block diagram of an apparatus for mapping and visualizing time-series information to a three-dimensional (3D) spatial model according to an example embodiment of the present invention.

Referring to FIG. 1, an apparatus 100 for mapping and visualizing time-series information to a 3D spatial model according to an example embodiment of the present invention may include a time-series information provider 10, a spatial information provider 20, a time-series information mapping 3D facility model generator 30, a time-series information retriever 40, a time-series information 3D facility mapper 50, a time-series information 3D facility mapping integration visualizer 60, and a user query processor 70.

First, the time-series information provider 10 includes a household-specific time-series information provider 11 and a group-specific time-series information provider 12.

Household-specific time-series information is time-series information on each measurement unit of a single household, and may include information such as apartment-household-specific daily, weekly, monthly, quarterly, and annual electricity usage, water usage, and heating service usage. Group-specific time-series information is time-series information on each measurement unit including several households, and may include information such as apartment-building-specific and apartment-complex-specific heating service usage.

The time-series information provider 10 may include various databases. The household-specific time-series information provider 11 may store time-series information stored according to households, and the group-specific time-series information provider 12 may store one of information on groups constituted of households and time-series information on the groups.

In the case of an apartment complex, information on a group constituted of households may be, for example, information for linking households constituting building #101 to a group “building #101.” Time-series information on a group may be obtained by gathering time-series information on households constituting the group, or time-series information mapped to the group may be gathered, calculated, and stored in advance as time-series information on the group.

The spatial information provider 20 provides various pieces of spatial information required to build a 3D virtual city model, and includes a 3D facility model provider 21, a 3D terrain information provider 22, a video information provider 23, a two-dimensional (2D) map information provider 24, and a building information provider 25. These pieces of information are integrated and visualized in the form of a 3D virtual city model by the time-series information 3D facility mapping integration visualizer 60, which will be described later.

The 3D facility model provider 21 of the spatial information provider 20 provides a 3D facility model created in advance, and the 3D terrain information provider 22 provides information on a terrain on which 3D facility models are put. The video information provider 23 provides video information, etc. that can be texture-mapped to the 3D facility model or 3D terrain. The 2D map information provider 24 and the building information provider 25 provide information that can be used to generate a simple 3D facility model in the form of a box for time-series information mapping when no 3D facility model is present.

In general, a 3D facility model used in a 3D virtual city model is very precisely modeled after its original shape and provided. Also, a 3D facility model generally has a structure in which it is difficult to distinguish between household-specific geometries, and is created only to visualize the external shape of a facility. Thus, it is inefficient to map and visualize household-specific time-series information to such a model, and a simple structure in which household-specific geometries can be distinguished from each other is required to map time-series information thereto.

The time-series information mapping 3D facility model generator 30 receives information from the above-described spatial information provider 20 and generates a 3D facility model for time-series information mapping having a simple structure for time-series information mapping in which household-specific geometries can be distinguished from each other.

If such a 3D facility model for time-series information mapping is created once, various pieces of time-series information may be mapped to the 3D facility model, and thus it is preferable to create and store a 3D facility model in advance and reuse it. Basically, the time-series information mapping 3D facility model generator 30 generates a 3D facility model for time-series information mapping on the basis of information received from the spatial information provider 20 and stores the 3D facility model in a time-series information mapping 3D facility model database 31.

As a type of information that can be provided by the spatial information provider 20, a 3D facility model created in advance and provided by the 3D facility model provider 21 may be used by the time-series information mapping 3D facility model generator 30.

Additionally, the building information provider 25 of the spatial information provider 20 provides building registration information and building design drawings to the time-series information mapping 3D facility model generator 30, so that a simple 3D facility model for time-series information mapping can be generated in the form of a box with building layer information in the 2D map information provider 24 even when no 3D facility model has been created for the corresponding building.

The time-series information mapping 3D facility model generator 30 has a function of automatically or manually generating a 3D facility including facilities belonging to the same group. For example, a function of generating a virtual 3D apartment complex model including apartment buildings included in the same apartment complex may be prepared. A 3D facility model for time-series information mapping may include a hierarchically created model of facilities belonging to the same group. In other words, a 3D facility model needs to be a hierarchical 3D model including facilities belonging to the same group. In the case of an apartment complex, a 3D model needs to be created to show an apartment complex shape including all buildings belonging to the same complex. For example, 3D facility models of respective buildings belonging to the same apartment complex are included the same group.

The time-series information retriever 40 retrieves time-series information corresponding to a time designated for a type of time-series information selected by a user. Household-specific time-series information or group-specific time-series information on a facility included in a current screen is retrieved according to a zoom level.

Using user information included in the time-series information on the facility included in the current screen that the level of detail (LOD)-based time-series information retriever 40 retrieves from the time-series information mapping 3D facility model database 31 according to the zoom level, the time-series information 3D facility mapper 50 retrieves a 3D facility and determines the corresponding position in the retrieved 3D facility model.

While visualizing a 3D virtual city model, the time-series information 3D facility mapping integration visualizer 60 integratedly visualizes a result of precisely mapping time-series information to the corresponding facilities using the result of the time-series information 3D facility mapper 50, thereby providing 3D spatial distribution of the time-series information. The time-series information 3D facility mapping integration visualizer 60 generates a 3D virtual city model using 3D terrain information that is provided by the spatial information provider 20 and relates to a terrain on which 3D facility models are put and video information that is image information which can be texture-mapped to a 3D facility model or 3D terrain together with the result of the time-series information 3D facility mapper 50.

The user query processor 70 receives a desired type of time-series information and an option for showing time-series information input by the user, extracts desired time-series information in response to a query passed through the LOD-based time-series information retriever 40, and outputs a 3D spatial model to which time-series information is mapped through the time-series information 3D facility mapping integration visualizer 60.

Method of Mapping and Visualizing Time-Series Information to 3D Spatial Model According to Example Embodiment of Present Invention

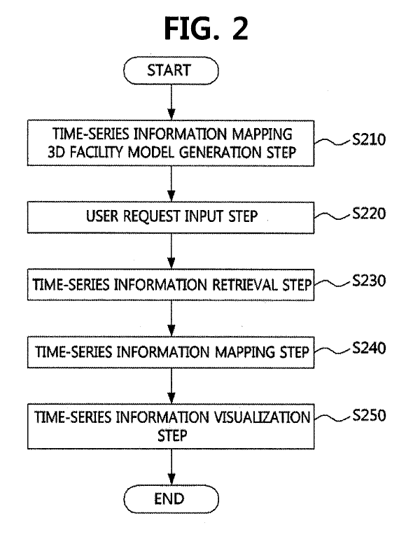

FIG. 2 is a flowchart illustrating a method of mapping and visualizing time-series information to a 3D spatial model according to an example embodiment of the present invention.

Referring to FIG. 2, a method of mapping and visualizing time-series information to a 3D spatial model according to an example embodiment of the present invention may include a time-series information mapping 3D facility model generation step (S210), a user request input step (S220), a time-series information retrieval step (S230), a time-series information mapping step (S240), and a time-series information visualization step (S250).

First, in the time-series information mapping 3D facility model generation step (S210), a 3D facility model for time-series information mapping is generated using a 3D facility model.

Assuming that the constitution of FIG. 1 according to an example embodiment of the present invention is used, the time-series information mapping 3D facility model generator 30 may receive a 3D facility model from the spatial information provider 20, generate a 3D facility model for time-series information mapping, and store the generated 3D facility model for time-series information mapping in the model database 31.

At this time, if no 3D facility model has been created for a target, 2D map information and building information including building registration information and building design drawings may be input, and a 3D facility model for time-series information mapping may be generated in the form of a box using a building layer of the 2D map information.

Next, in the user request input step (S220), a type of desired time-series information and a time-series information showing method input by a user are received.

Assuming that the constitution of FIG. 1 according to an example embodiment of the present invention is used, the user request input step (S220) may be performed by the user query processor 70, and information on the type of time-series information and the time-series information showing method desired by the user are input through a graphical user interface (GUI), or so on.

The type of time-series information may be information indicating whether the time-series information desired by the user is household-specific time-series information or time-series information according to groups constituted of households, and information indicating the type of time-series information, for example, hourly, daily, weekly, monthly, quarterly and annual electricity usage, water usage and heating service usage.

Time-series information may be automatically expressed according to a zoom level, and a time-series information showing method may be a showing method desired by the user.

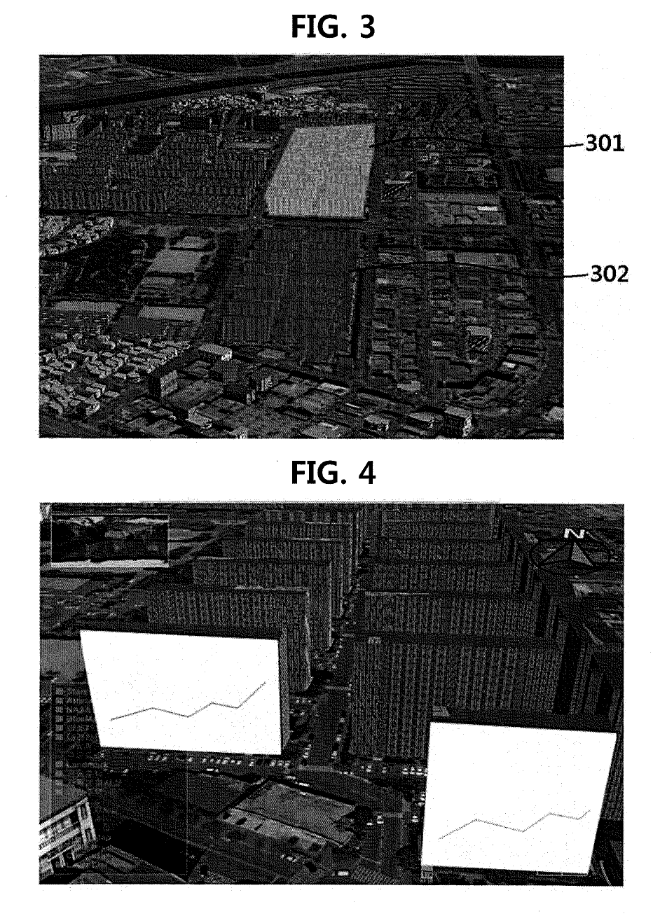

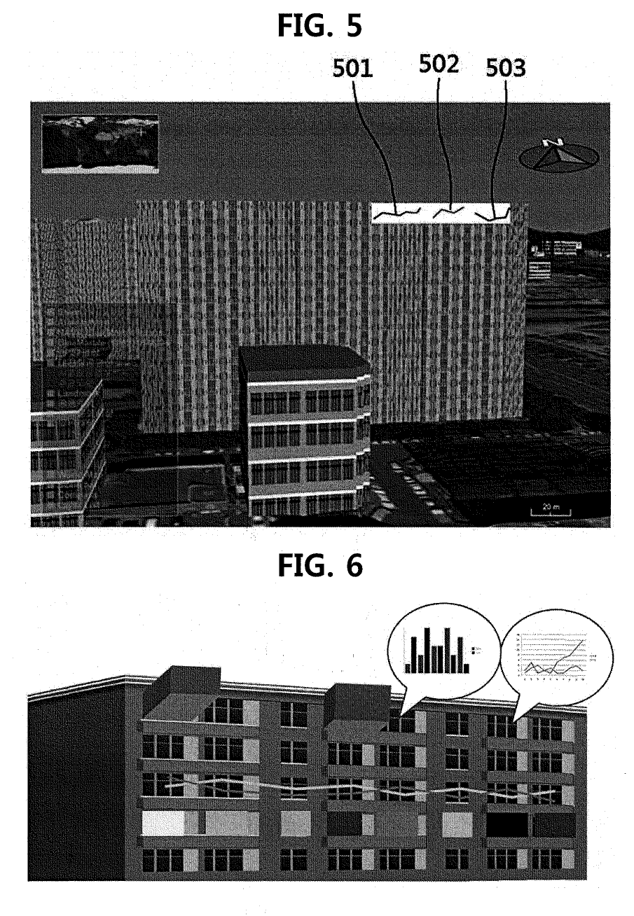

FIG. 3 is a conceptual diagram of an example in which time-series information is visualized according to building groups using a mapping and visualization method according to an example embodiment of the present invention, and FIG. 4 is a conceptual diagram of an example in which building-unit-specific time-series information is visualized using a mapping and visualization method according to an example embodiment of the present invention. FIGS. 5 and 6 are conceptual diagrams of examples in which time-series information according to households in a unit building is visualized using a mapping and visualization method according to an example embodiment of the present invention.

Referring to the visualization examples of time-series information shown in FIGS. 3 to 5 according to an example embodiment of the present invention, time-series information may be basically visualized in three levels, that is, showing group-specific information as shown in FIG. 3, showing unit-facility-specific information as shown in FIG. 4, and showing household-specific information in a unit facility as shown in FIG. 5, according to a zoom level.

FIG. 3 shows a visualization example of building-group-specific time-series information in which the time-series information is shown according to apartment complexes. For example, an apartment complex 301 colored yellow may have further used a specific amount of electricity or more in comparison with an apartment complex 302 colored red.

FIG. 4 shows a visualization example of building-unit-specific time-series information in which a change in electricity usage is shown according to apartment buildings.

FIG. 5 shows a visualization example of time-series information according to households in a unit building in which changes in heating service usage of specific households 501, 502 and 503 on a specific floor of a specific apartment building are shown.

Next, in the time-series information retrieval step (S230), time-series information required to be visualized is retrieved on the basis of the information on the type of time-series information and the time-series information showing method input in the user request input step (S220).

Assuming that the constitution of FIG. 1 according to an example embodiment of the present invention is used, the time-series information retrieval step (S230) may be performed by searching the time-series information provider 10 through the time-series information retriever 40 on the basis of information on the type of time-series information and the time-series information showing method desired by the user and input through the user query processor 70.

Like in the above-described user request input step (S220), time-series information may be automatically retrieved according to the time-series information showing method desired by the user and an LOD dependent on a zoom level. For example, when the user requests monthly electricity usage of all households of apartment building #101, information on monthly electricity usage of all the households constituting apartment building #101 corresponding to a designated period is retrieved from the time-series information provider 10.

Next, in the time-series information mapping step (S240), the retrieved time-series information is mapped to the generated 3D facility model according to the input time-series information showing method.

Assuming that the constitution of FIG. 1 according to an example embodiment of the present invention is used, the time-series information mapping step (S240) may serve to map the time-series information retrieved by the time-series information retriever 40 to the 3D facility model for time-series information mapping generated by the time-series information mapping 3D facility model generator 30. In other words, the time-series information mapping step (S240) is performed by the time-series information 3D facility mapper 50.

Finally, in the time-series information visualization step (S250), the 3D facility model generated in the time-series information mapping step (S240) and the time-series information mapped to the 3D facility model are integratedly visualized. At this time, the 3D facility model for time-series information mapping generated in the time-series information mapping step (S240) and the time-series information mapped to the 3D facility model may be clipped and visualized according to an area shown in a current screen that can be moved using a mouse by the user in step 250.

FIG. 6 is a conceptual diagram of another example in which time-series information according to households in a building is visualized using a mapping and visualization method according to an example embodiment of the present invention.

Referring to FIG. 6, time-series information may be shown by modifying the geometry of the corresponding household, or in the form of a line or using color in the geometry of the household. Also, various pieces of information may be shown in the form of a marker in the geometry of the corresponding household.

Additionally, to show information on a specific facility when time-series information is visualized, a function of hiding 3D information in units of adjacent facilities may be provided. Also, a function of grouping and showing information on several households of a single facility according to households when the information is visualized may be provided. For example, a function of visualizing floor-specific and line-specific time-series information may be provided to visualize household-specific information on each apartment building.

In the description above, a visualization method may be diversified, and each visualization method maps and shows time-series information to the corresponding position of a reference 3D model.

The above-described apparatus and method for mapping and visualizing time-series information to a 3D spatial model according to example embodiments of the present invention precisely map and visualize household-specific time-series information indirectly expressing positions in a 3D space to the corresponding 3D positions of a 3D spatial model, and thus can integratedly visualize time-series information in a 3D virtual city model.

Also, the apparatus and method automatically group and visualize time-series information according to a zoom level, and thus can visualize a huge amount of time-series information according to an LOD. In other words, time-series information according to building groups, time series information according to building units, and time-series information according to households in a building can be mapped to the corresponding 3D spatial model and recognized. Thus, it is possible to know 3D distribution of household-specific time-series information in a 3D virtual city model.

While the example embodiments of the present invention and their advantages have been described in detail, it should be understood that various changes, substitutions and alterations may be made herein without departing from the scope of the invention.

What is claimed is:

1. An apparatus for mapping and visualizing time-series information to a three-dimensional (3D) spatial model, comprising:
a time-series information provider configured to store household-specific time-series information;
a spatial information provider configured to store a 3D facility model;
a time-series information mapping 3D facility model generator configured to receive the 3D facility model from the spatial information provider and generate a 3D facility model for time-series information mapping;
a user query processor configured to receive a type of desired time-series information and a time-series information showing method input by a user;
a time-series information retriever configured to retrieve the desired time-series information input to the user query processor from the time-series information provider;
a time-series information 3D facility mapper configured to map the desired time-series information retrieved by the time-series information retriever to the 3D facility model for time-series information mapping generated by the time-series information mapping 3D facility model generator according to the time-series information showing method input to the user query processor; and
a time-series information 3D facility mapping integration visualizer configured to integratedly visualize the mapping result of the time-series information 3D facility mapper.

2. The apparatus of claim 1, wherein the time-series information provider stores at least one of information on groups constituted of households and time-series information according to the groups constituted of the households in addition to the household-specific time-series information.

3. The apparatus of claim 1, wherein the spatial information provider additionally stores two-dimensional (2D) map information and building information including building registration information and building design drawings.

4. The apparatus of claim 3, wherein the time-series information mapping 3D facility model generator generates the 3D facility model for time-series information mapping by additionally using the 2D map information and the building information including the building registration information and the building design drawings provided by the spatial information provider.

5. The apparatus of claim 1, wherein the time-series information retriever and the time-series information 3D facility mapper determine a zoom level of the expression information on the basis of the time-series information showing method input through the user query processor according to a current zoom level.

6. The apparatus of claim 1, wherein the time-series information 3D facility mapping integration visualizer clips and visualizes the mapping result of the time-series information 3D facility mapper centering on an area included in a current screen.

7. The apparatus of claim 1, wherein the spatial information provider additionally provides 3D terrain information and video information, and
the time-series information 3D facility mapping integration visualizer visualizes the mapping result of the time-series information 3D facility mapper using the 3D terrain information and the video information.

8. A method of mapping and visualizing time-series information to a three-dimensional (3D) spatial model, comprising:
a time-series information mapping 3D facility model generation step of generating a 3D facility model for time-series information mapping using a 3D facility model;
a user request input step of receiving input information on a type of desired time-series information and a time-series information showing method;
a time-series information retrieval step of retrieving time-series information required to be visualized on the basis of the input information on the type of time-series information and the time-series information showing method;
a time-series information mapping step of mapping the retrieved time-series information to the generated 3D facility model according to the input time-series information showing method; and
a time-series information visualization step of integratedly visualizing the 3D facility model and the time-series information mapped to the 3D facility model.

9. The method of claim 8, wherein the time-series information is at least one of household-specific time-series information and time-series information according to groups constituted of households.

10. The method of claim 8, wherein the time-series information mapping 3D facility model generation step includes generating the 3D facility model for time-series information mapping using two-dimensional (2D) map information and building information including building registration information and building design drawings in addition to the 3D facility model.

11. The method of claim 8, wherein the time-series information retrieval step and the time-series information mapping step include determining the time-series information to be retrieved and a zoom level of the time-series information to be shown on the basis of the time-series information showing method input in the user request input step.

12. The method of claim 8, wherein the time-series information visualization step includes clipping and visualizing the mapping result of the time-series information mapping step centering on an area included in a current screen.

13. The method of claim 8, wherein the time-series information visualization step includes visualizing the mapping result of the time-series information mapping step using 3D terrain information and video information.
